(19) United States
(12) Patent Application Publication
(10) Pub. No.: US 2004/0112493 A1
(43) Pub. Date: Jun. 17, 2004

(54) Truck steer tire

(76) Inventors: Thomas Stephen Warchol, Peninsula, OH (US); Timothy Robert Richards, Akron, OH (US); Ronald Lawrence Loeffler, Akron, OH (US)

Correspondence Address: The Goodyear Tire & Rubber Company, Patent & Trademark Department - D/823, 1144 East Market Street, Akron, OH, 44316-0001, US

(21) Appl. No.: 10/318,898

(22) Filed: Dec. 13, 2002

(51) Int. Cl. B60C 11/01; B60C 11/13

(52) U.S. Cl. 152/209.16; 152/538; 152/454

(57) ABSTRACT

A truck steer tire 10 has a wide decoupling groove 24 that extends inwardly from the tread in a circumferentially continuous fashion. The decoupling groove 24 extends between the tread surface 26 and the belt reinforcing structure 15. The decoupling groove 24 has a width in the range of 4 to 7 mm and a groove bottom having a full radius of curvature R_{G}, R_{G} being at least 2.5 mm. The decoupling groove 24 has a point C, C being centered on the bottom of the full radius of curvature R_{G}, a line K drawn through the center C and the axially outermost end of the belt layers measures at least 10 mm and each axially outer end of the remaining belt layers is spaced greater than 10 mm from the center C.

### FIELD OF THE INVENTION

The present invention relates to truck tires for steer axles.

### BACKGROUND OF THE INVENTION

The use of treads specifically designed for the steer axle of truck tires has been directed to various forms of rib-type tires. This non-driving axle exhibits cornering and turning loads as well as straight line running loads. Some skilled in the art believe the tread ribs should ideally have a sharp edge adjacent to the circumferential grooves to provide improved handling.

These sharp edges during normal use can exhibit irregular tread wear. High wear erosion is common in the shoulder region of the tread. This problem was addressed in U.S. Pat. No. 4,480,671 issued Nov. 6, 1984, to Giron. As shown in FIG. 2, Giron disclosed the use of a laterally located circumferentially continuous rib 4 that under normal driving conditions is in contact with the road. The force or pressure exerted by the rib 4 on the road being less than the force or pressure of the shoulder rib 6. This prior art tire 2 relied on the laterally located rib to protect the sharp edge of the shoulder rib.

One such tire 2 is believed to be the Michelin XZA-1+ steer tire.

An alternative design approach was to have a non-recessed circumferential rib 3 adjacent a narrow circumferentially continuous groove 7 and shoulder rib 5. Such a tire was commercially sold as the Goodyear G259 steer tire and that tire 1 exhibits a static footprint or tread contact patch as shown in FIG. 3.

Another alternative design disclosed in U.S. Pat. No. 5,660,652 provided a decoupling groove with a very narrow width adjacent a decoupling rib that never contacted the road surface at least until the tire was about half worn. This concept has been used on the Goodyear G357 and G397 tires.

Yet another design approach was demonstrated by Bridgestone Tire & Rubber Company's R227 Steer Tire which has a narrow circumferentially continuous bent groove in the side of a shoulder rib. The narrow bent groove creates reduced shoulder pressure and acts as a decoupling groove as is taught in U.S. Pat. No. 4,995,437.

All of these design approaches rely on a decoupling groove in the tread. These features will effectively reduce shoulder wear when the tread is new. This has the remarkable benefit of inhibiting the onset of irregular wear. The tread shoulder is most prone to setting up irregular wear when the tread is new and is at a maximum tread thickness.

What is troubling though is that the decoupling ribs in the tread are prone to tearing and cutting while the decoupling groove can be prone to stone holding. As a result, this portion of the tread is potentially vulnerable to damage when the tire strikes a curb or other hard obstruction.

In order to insure that the tread is effectively decoupled from the sidewall, that is the tread shoulder remains somewhat independent of the forces exerted by the sidewall, a new and vastly improved way of decoupling must be provided.

The present invention provides a way to effectively decouple the tread shoulder.

The effective decoupling of the tread shoulder occurs in the treadwall region of the tread at a location radially outward or preferably directly above the axially outermost layer of the belt structure and, thus, above a tread buff line when the tire casing is prepared for retreading.

### SUMMARY OF THE INVENTION

A radial ply pneumatic tire for the steer axle of a commercial truck is described.

The tire has a tread and a casing. The casing has at least one radial ply extending to a pair of radially inner beads and a belt reinforcing structure disposed radially outward of the ply.

The tread is disposed radially outward of the casing. The tread also has a plurality of tread ribs including a pair of shoulder ribs. Each shoulder rib has an axially outer treadwall. Each axially outer treadwall is adjacent a radially inward extending circumferentially continuous decoupling groove.

The tread has a plurality of circumferentially continuous grooves, a pair of radially recessed ribs, the rib being radially recessed and non-road contacting under static load, a pair of full radius circumferentially continuous decoupling grooves. One full radius circumferentially continuous decoupling groove is adjacent each recessed rib.

The radially outer surfaces of the plurality of tread ribs lying between and including the shoulder ribs, but excluding the recessed ribs, define a radially outer tread surface. The outer tread surface is adjacent to and extends between the pair of full radius circumferential decoupling grooves. The radially outer tread surface has a maximum diameter D at the tread centerline and preferably a constant radius of curvature R, R extending laterally toward each circumferential decoupling groove. The constant radius of curvature R originates on the centerline of the tread. The axial width of the tread is W, W being measured between axially outer lateral edges of the shoulder ribs. The distance halfway between the lateral edges defines the centerline CL of the tread. The lateral edges are defined as the locations of the tire intersections of the radially outer tread surface and the treadwalls of each shoulder rib.

The tire has a belt structure. The belt structure has a plurality of belt layers. A first radially inner belt layer, a second intermediate belt layer, an optional third intermediate belt layer and a radially outer belt layer each belt layer has an axially outer end.

Each decoupling groove has a full radius of curvature R_{G}. R_{G} is at least 2.0 mm, preferably 2.5 mm, and at a point C centered on the bottom of the full radius of curvature R_{G}, a line K drawn through the point C, and the axially outermost end of the belt layers measures at least 10 mm, preferably 13 mm, and each axially outer end of the remaining belt layers is spaced greater than 10 mm from the point C.

Each tread shoulder rib has an axially outermost edge intersecting a lateral edge. The axially outermost edge lies on a line J. J is parallel to K and intersects only the belt layer having the axially outermost end. The line J extends from the axially outermost tread edge inwardly a distance of at least 40 mm to the radially inner surface of the carcass when the tire is new. J intersects the ply cords of the normally inflated tire on a line substantially perpendicular to the cord path of the ply.

### DEFINITIONS

“Apex” means an elastomeric filler located radially above the bead core and between the plies and the turnup ply.

“Bead” means that part of the tire comprising an annular tensile member wrapped by or otherwise anchored by ply cords and shaped, with or without other reinforcement elements such as flippers, chippers, apexes, toe guards and chafers, to fit the design rim.

“Belt Structure” means at least two annular layers or plies of parallel cords, woven or unwoven, underlying the tread, unanchored to the bead, and having both left and right cord angles in the range from 15° to 68° with respect to the circumferential centerline of the tire.

“Casing” means the carcass, belt structure, beads, sidewalls, and all other components of the tire excepting the tread and undertread. The casing may be new, unvulcanized rubber or previously vulcanized rubber to be fitted with a new tread.

“Chafers” refers to narrow strips of material placed around the outside of the bead to protect cord plies from the rim, distribute flexing above the rim, and to seal the tire.

“Circumferential” means lines or directions extending along the perimeter of the surface of the annular tread perpendicular to the axial direction.

“Cord” means one of the reinforcement strands of which the belts and plies in the tire are comprised.

“Lateral” means an axial direction.

“Ply” means a continuous layer of elastomeric rubber-coated parallel cords.

“Radial” and “radially” mean directions radially toward or away from the axis of rotation of the tire.

“Radial Ply Tire” means a belted or circumferentially-restricted pneumatic tire in which the ply cords which extend from bead to bead are laid at cord angles between 65° and 90° with respect to the equatorial plane of the tire.

“Shoulder” means the upper portion of sidewall just below the tread edge; tread shoulder or shoulder rib means that portion of the tread near the shoulder.

“Sidewall” means that portion of a tire between the tread and the bead.

“Tread” means a rubber or elastomeric component including that portion of the tire that comes into contact with the road under normal inflation and load.

### BRIEF DESCRIPTION OF THE DRAWINGS

The invention will be described by way of example and with reference to the accompanying drawings in which:

FIG. 1 is a cross-sectional view of the tire 10 according to the present invention.

FIG. 2 is a partial cross-sectional view of a prior art tire 2 disclosed in U.S. Pat. No. 4,480,671.

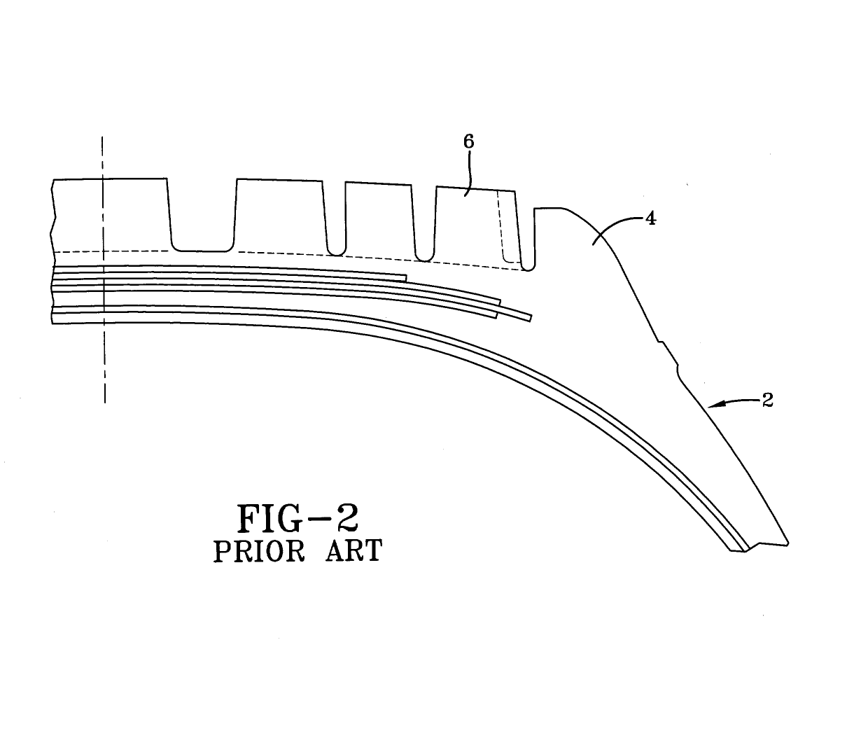

FIG. 3 is an exemplary static footprint of a prior art tire 1 commercially sold as the Goodyear G259.

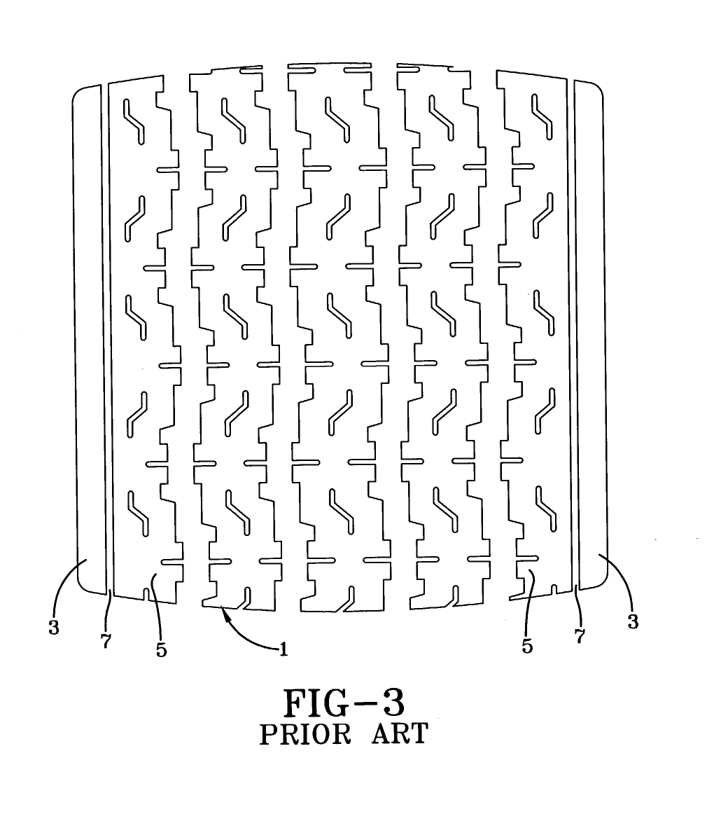

FIG. 4 is an illustration of a prior art exemplary tire footprint exhibiting shoulder rib cupping after 100,000 miles of use.

FIG. 5 is an exemplary tire footprint of the present invention depicting the pressure distribution of the tire as molded.

FIG. 6 is an enlarged cross-section of one-of the tire shoulders of the preferred tire according to the invention.

FIGS. 7A and 7B are cross-sections of an alternative embodiment tire shoulders of the present invention.

### DETAILED DESCRIPTION OF THE INVENTION

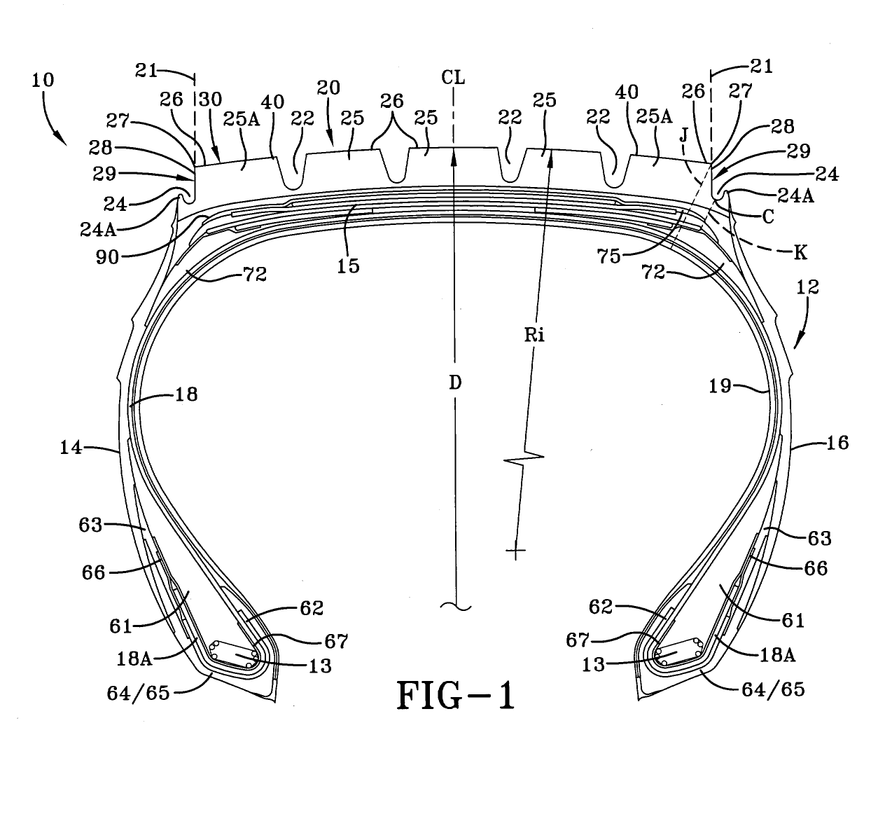

With reference to FIG. 1, a cross-section of the pneumatic radial tire 10 for use on steering axles is illustrated.

The tire 10 has a tread 20 and a casing 12. The casing 12 has two sidewalls 14,16 one or more radial plies 18 extending from and preferably wrapped about or otherwise secured to two annular beads 13 and a belt reinforcement structure 15 located radially between the tread 20 and the plies 18.

The plies 18 and the belt reinforcement structure 15 are cord reinforced elastomeric material, the cords being preferably steel wire or polyamide filaments and the elastomer preferably being a vulcanized rubber material. Similarly, the annular beads 13 have steel wires wrapped into a bundle known as the bead core.

A liner 19 component of preferably halobutyl rubber forms a somewhat air impervious chamber to contain the air pressure when the tire 10 is inflated.

The casing 12 of the preferred embodiment of the invention, as illustrated in FIG. 1, employed a bead 13 having an 8×10×9 hexagonal bead core having an elastomeric apex 61 radially above the bead 13. The ply turnup 18A in the bead area was reinforced with a flipper 67, chipper 62, gum and fabric chafers 64,65, gum strips 66 and elastomeric wedges 63.

Additionally, the belt reinforcement structure 15 included gum strip of rubber material 75 and a plurality of elastomeric strips or wedges 72 in the lateral extremes of the belts 15 in proximity of the decoupling grooves 24. Although not required to the practice of the inventive concept, these features are disclosed as features employed in the preferred embodiment.

The tread 20 has a plurality of circumferentially continuous grooves 22 and a plurality of tread ribs 25, including a pair of shoulder ribs 25A, one shoulder rib 25A being adjacent each lateral edge 21 of the tread 20.

The distance halfway between the lateral edges 21 of the tread defines the circumferential centerline CL of the tread 20.

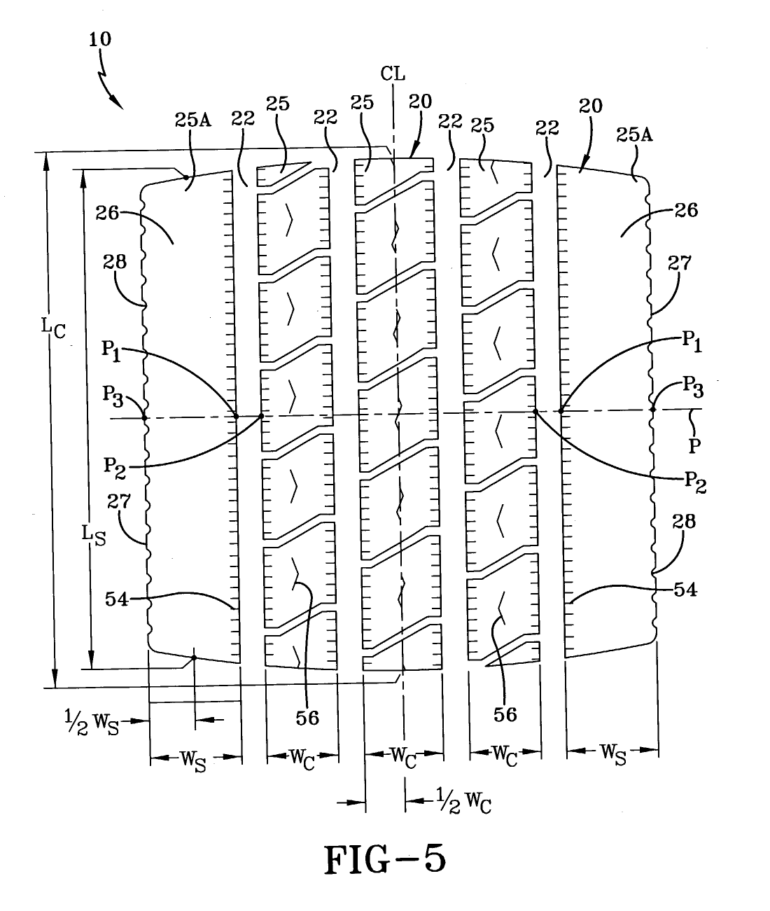

The radially outer road contacting surfaces 26 of the plurality of tread ribs 25, 25A define a radially outer tread surface 30. The outer tread surface 30 is adjacent to and extends between the pair of lateral edges 21. A plurality of sipes or incisions 54 and 56 are preferably employed on the tread 20 as shown in FIG. 5.

As shown in FIG. 1, a radially inwardly extending circumferential decoupling groove 24 is located adjacent to each shoulder rib 25A.

As shown in FIG. 5, the tread 20, when new, exhibits a static footprint pressure distribution when the tire is normally loaded, such that the pressure exerted along the axial centerline C of the footprint on the shoulder rib 25A adjacent the lateral edge 21 is P₃, on the shoulder rib 25A adjacent the circumferential groove 22 is P₁, on the rib 25 laterally adjacent the shoulder rib 25A at the groove 22 is P₂. The relationship of the pressure distribution is P₁ is about equal to P₂; and about 110% P₃. P₃ preferably is about 90% of P₁.

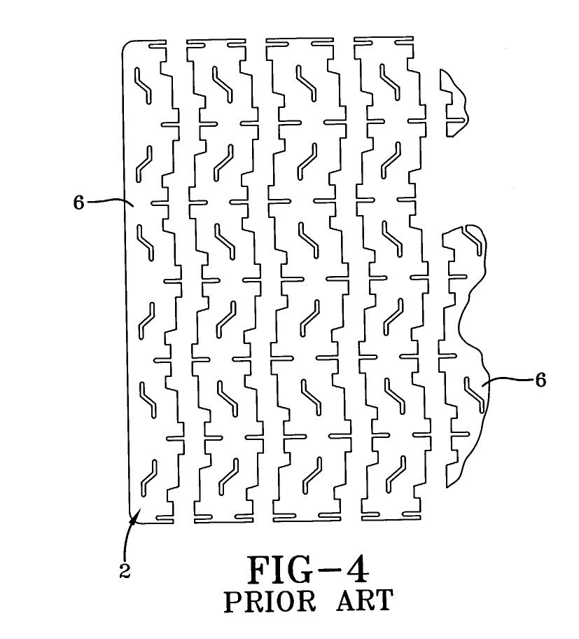

As shown in FIG. 4, a prior art tire 1, the G259 after 100,000 miles of wear can exhibit considerable cupping wear in the shoulder rib region 2. The decoupling or recessed lateral rib 6 is noticeably worn away from road contact at this wear condition. The tire 10 according to the preferred embodiment of the invention, as illustrated in FIG. 1, has a much more uniform wear in the same shoulder regions of the tread 20. Both the prior art tire 1 and the test tires 10 were of similar size, 295/75R22.5 and 11R22.5, and similarly loaded and inflated during the evaluations.

As shown in FIGS. 1 and 5, the above-described pressure distribution exhibited by tire 10 is partly achieved by effectively progressively increasing the width W_{S} of the tread shoulder rib 25A as compared to width W_{C} of the ribs 25. The area directly adjacent the decoupling grooves 24 improves the maintenance of the radius R of the tread.

Interestingly an upper limit in the amount of pressure change must be maintained wherein P₃ should not exceed P₁. If too much rubber is added to the shoulder rib 25A adjacent the decoupling grooves 24, the area adjacent the circumferential groove 22 can become too lightly loaded. When this condition occurs a phenomena known as erosion wear or river wear can occur adjacent the groove 22. To prevent this problem from occurring a balance must be maintained. Ideally, both edges across the shoulder ribs 25A wear at the same uniform rate. This condition achieves a most beneficial projected mileage life of the tread.

In the tire of FIG. 1 the tread radius of curvature Rᵢ was selected to be about 25 inches (74 cm). A single radius Rᵢ provides a simple mold shape. Alternatively multiple radii of curvature Rᵢ can be used. In those cases the radius Rᵢ nearest the centerplane CL can be about 25 inches (64 cm) and radii near to the shoulder preferably is substantially larger. All of these tread shapes are feasible due in part to the decoupling grooves 24 in the upper treadwall 29 enabling the tire engineer to select the tread shape most preferred for the particular application.

Ideally the decoupling grooves 24 are positioned at a radial height at or above the edges of the belt structure as is illustrated. Under normal load the decoupling grooves 24 compress slightly causing the tread to exhibit a lower contact pressure at the tread ribs 25A and reduce torquing of the shoulder rib. These grooves 24 preferably have an end or bottom formed by a full radius R_{G}, the full radius R_{G} extending a fixed or predetermined distance (d) inwardly from the recessed rib 24A toward the underlying belt layers 15.

As the tire rotates under load, the decoupling grooves 24 compress. This ability to compress greatly facilitates the ability of the tread to maintain its shape in turning and cornering maneuvers.

The tread 20 at the axially outer portion of the tread shoulder rib 25A has a treadwall 29. The treadwall 29 as shown may include an undulating surface 28 extending to the edge 27. As shown, this portion of the tread shoulder rib 25A extends radially outward of the decoupling grooves 24.

As shown in FIG. 5, when the tread is new the footprint or contact patch of the tire exhibits a contact pressure as measured along a line P spaced equidistant between a leading edge and a trailing edge of the tires normally loaded and normally inflated static condition. The distance L_{C} defines the contact patch length at the centerplane CL while the distance L_{S} is the length of the contact patch in the center of the shoulder ribs. Preferably L_{C} is greater than or equal to L_{S}. The normally inflated condition as used herein means the design inflation pressure P_{N}. At the edge 27 of rib 25A intersecting the line P a contact pressure P₃ is shown. On the opposite side of the rib 25A adjacent the groove 22 intersecting line P a contact pressure P₁ is shown. On the opposite groove wall of adjacent rib 25 along the line P a contact pressure P₂ is shown. These contact pressures can be adjusted upward by elevating the edge 27 relative to the contour of the central portion of the tread 20 as defined by the radius Rᵢ or lowered by lowering the edge 27 relative to the contour of the central portion of the tread 20, assuming a tread surface contour using a curvature having more than a single radius of curvature is used.

An important feature of the preferred embodiment tire is that the axial widths W_{C} of the tread ribs 25 are actually smaller in width than the axial width W_{S} of the shoulder ribs 25A. These are average widths as measured halfway across each respective tread rib 25 and ribs 25A. Preferably W_{S} of the shoulder ribs 25A are at least 10% greater in width than the central ribs 25 width W_{C}. This feature helps insure the shoulder ribs 25A can have an overall lower pressure distribution than the central ribs portion of the tread. Ideally the shoulder ribs 25A have a contact pressure equal to or less than the central ribs 25. The contact pressure of the shoulder ribs should be less than the inflation pressure P_{N} while the central ribs contact pressure is equal to or greater than the pressure P_{N}. All of these pressure distribution relationships are achieved by a combination of tread arc curvatures, rib width variations and the unique location decoupling grooves 24. The decoupling grooves 24 enable the tire designer to stiffen or soften the tread edge 27 by simply adjusting the depth, width or shape of the grooves 24, their location or their axial extent. These features can be tuned individually or collectively to enhance tire performance and tread wear. This is very beneficial in several ways not the least of which is achieving a more durable tread that wears uniformly without requiring a tread decoupling rib that is road contacting which had been considered the most reliable way to design a tread for a steer tire.

As shown the axial location C of the grooves 24 should be closest to the location of the lateral outermost edge of the working belts 15 as in FIGS. 1 and 6 and FIGS. 7A and 7B.

In essence the entire invention principle achieved by the use of decoupling grooves 24 resides in the desensitization of the shoulder pressure to varying loads. The loads of a steer axle tire vary due to the vertical and lateral movements of the tire. The prior art tires exhibit a higher sensitivity of shoulder pressure to load variation when compared to the tire of the present invention.

Naturally the lower contact pressure achieved at the edge can be advantageous in some cases as well, but in other cases it may be beneficial to increase the contact pressure at location P₃. The decoupling grooves 24 allow the engineer to achieve these benefits as well.

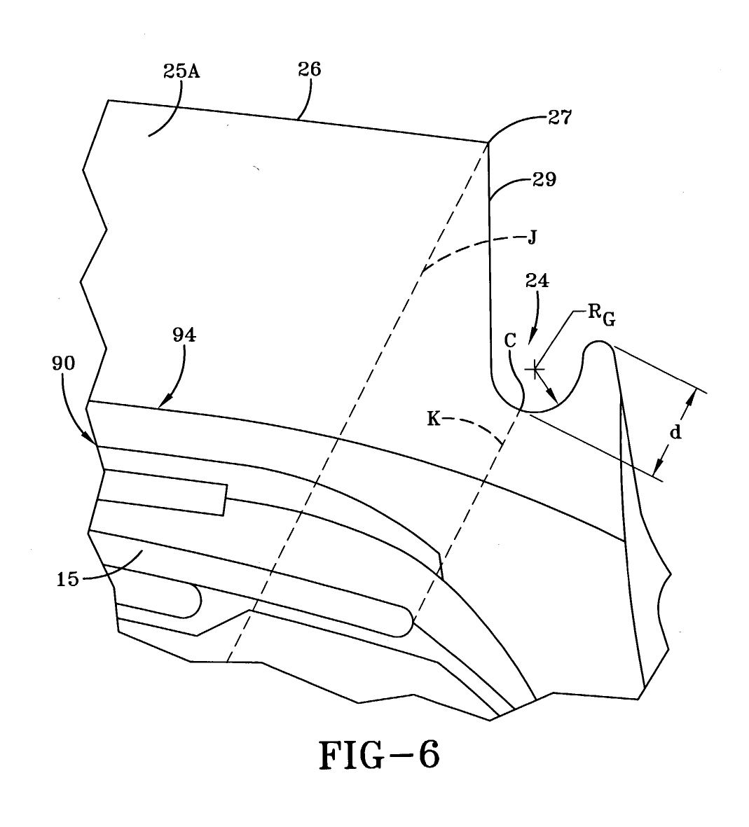

With reference to FIG. 6, one embodiment of the invention is shown with an enlarged view of the tire's shoulder shown in cross section.

A line K drawn from the edge of the widest reinforcing belt 15 to the point C established the distance of the decoupling groove 24 from the closest belt layer. For any particular tire the decoupling groove 24 should have the end or dome at point C at least 10 mm, preferably 13 mm from the axially outermost end of the widest belt layer.

Ideally the decoupling groove 24 lies at least 10 mm above the belt reinforcing structure 15. It is believed important that no part of the decoupling grooves 24 should be below the tread to casing interface 90. If possible the decoupling groove should be entirely in the tread material and not extend beyond the tread cap/base interfacial line 94.

As shown the decoupling groove 24 has the width (w) of the decoupling groove in the range of 4.0 mm and 7.0 mm. The preferred width (w) is 5.0 mm. The radius R_{G} of the dome or base of the groove should be as large as possible.

As shown in FIG. 6, the belt reinforcing structure has four belt layers; the first layer has preferably high angle cords in the 50 to 65° degree ranges relative to the equatorial plane or centerplane of the tire 10. The first belt layer is commonly referred to as a transition belt layer. The next two layers have steel cords oriented in the 16° to 22° range, preferably about 18° as shown. The final or outer layer has synthetic cords of preferably nylon oriented, also in the 16° to 22° range. The use of more or less belt layers is feasible depending on the demands or service conditions for the particular tire.

As shown the decoupling groove 24 is spaced from the belts a distance of at least 10 mm from the location C. In particular, along the line K which intersects the end of axially outermost working belt layer, the working belt layers being those with cords oriented in the 18° to 22° range; are the shortest distance to the point C. Furthermore, a line J drawn parallel to the line K should only intersect the axially widest working belt, the line J being the line that intersects the tread edge 27 at the intersection of the tread wall 29 and the tread's radially outer surface 30. The line J is also substantially perpendicular to the ply cord path at that point of intersection. The distance of the tread edge 27 to the innerliner should be at least 40 mm on the tire when new. These relationships insure the tread shoulder rib 25A adjacent the decoupling groove 24 has a softer spring rate or pressure as the tire's footprint is entered into. This greatly facilitates the ability of the tread 20 to flex adjacent the decoupling groove 24, a feature that is important to steer tires.

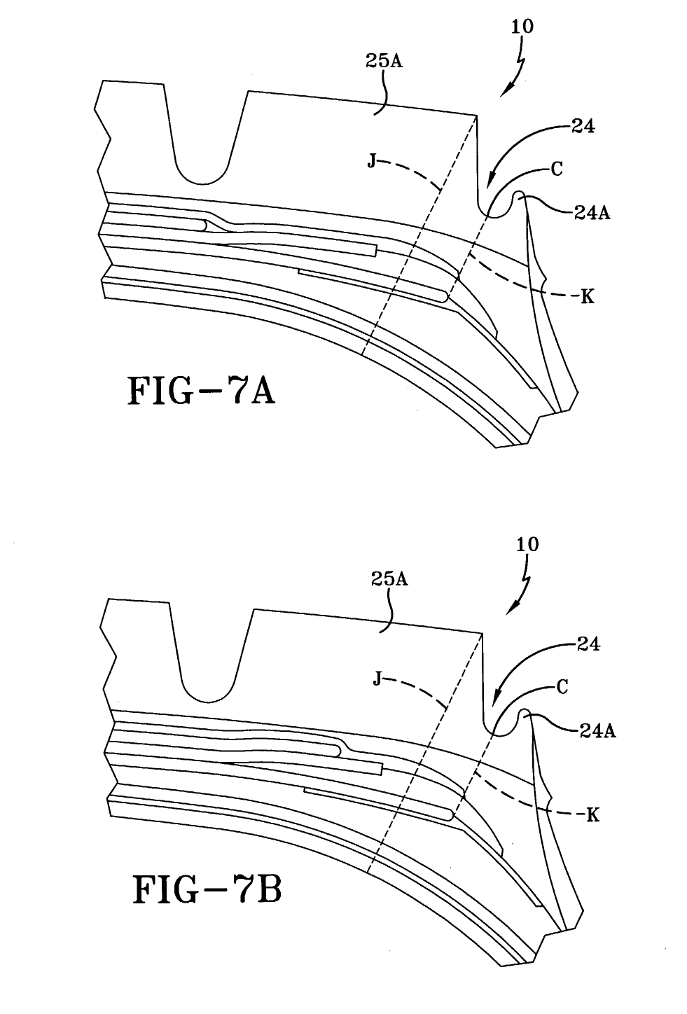

As shown, in FIGS. 7A and 7B alternative belt structure 15 may be employed. Currently, some manufacturers of tires are using three belt layers in place of the four belt layers shown in FIGS. 1 and 6. These constructions achieve a weight savings advantage. Nevertheless, the principles taught in the preceding discussion still apply. The location C, lines K and J all should be positioned as was stated for the four belt layer. In the three belt layer construction the axially widest belt layer should have the line K intersect the end and the point C at a distance no less than 10 mm and the tread edge should be located such that the line J parallel to K intersects only the widest belt layer. Assuming these conditions are satisfied the beneficial aspects of the wide decoupling groove can be achieved as discussed.

As shown in FIGS. 1 and 6 the recessed rib 24A adjacent the decoupling groove 24 is very reduced in radial height as compared to the prior art steer tires. As shown the recessed rib projects outwardly a distance (d) of 25% or less of the full nonskid tread depth. For the illustrated embodiment the non-skid tread depth is 14.5 mm and the recessed rib is 11.5 mm inward of the outer surface 30, the rib 24A being only 3 mm above the tread line 93, or about 5 to 7 mm above the point C. The shallow rib has been found to be very durable and avoids tearing but also the shallow rib 24A prevents stone retention.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic radial ply truck tire for use on steering axles, comprising a tread, a casing, the casing having two sidewalls, one or more radial plies extending from and anchored to two annular beads, a belt reinforcement structure located radially between the tread and the plies, the tire characterized by the tread having a plurality of circumferentially continuous grooves, a pair of radially recessed ribs, the radially recessed ribs being radially recessed and non-road contacting under static load, a pair of full radius circumferentially continuous decoupling grooves, one full radius circumferentially continuous decoupling groove being adjacent each recessed rib, and a plurality of tread ribs, including a pair of shoulder ribs, one shoulder rib being adjacent each circumferential decoupling groove, the radially outer surfaces of the plurality of tread ribs defining a radially outer tread surface, the outer tread surface being adjacent to and extending between the pair of full radius circumferential decoupling grooves, the distance halfway between the decoupling grooves defining the centerline of the tread, in a cross section of the tread, the radially outer tread surface has a maximum diameter D at the tread centerline and a constant radius of curvature R, R extending laterally toward each circumferential decoupling groove, the constant radius of curvature R originating on the centerline of the tread, the axial width of the tread being W as measured between lateral edges of the shoulder ribs; the belt structure having a plurality of belt layers, a first radially inner belt layer, a second intermediate belt layer, a third intermediate belt layer and a radially outer belt layer each belt layer having an axially outer end; and
wherein each decoupling groove has a full radius of curvature R_{G}, R_{G} being at least 2.0 mm and at a point C centered on the bottom of the full radius of curvature R_{G} a line K drawn through the center C and to the axially outermost end of the belt layers measures at least 10 mm and each axially outer end of the remaining belt layers is spaced greater than 10 mm from the center C.

2. The pneumatic radial ply truck tire for use on steering axles of claim 1 wherein each tread shoulder rib has an axially outermost edge intersecting a lateral edge, the axially outermost edge lies on a line J, J being parallel to K and intersecting only the belt layer having the axially outermost end.

3. The pneumatic radial ply truck tire for use on steering axles of claim 3 wherein the line J extends from the axially outermost tread edge inwardly a distance of at least 40 mm to the radially inner surface of the carcass.

4. The pneumatic radial ply truck tire for use on steering axles of claim 3 wherein J intersects the ply cords of the normally inflated tire on a line substantially perpendicular to the cord path.

5. The pneumatic radial ply tire for use on steering axles of claim 4 wherein the tread radius R is at least 460 mm.

6. The pneumatic radial ply tire of claim 1 wherein the radius R_{G} is 2.5 mm and the distance between the point C and the closest belt is 13 mm.
